(19) United States
(12) Patent Application Publication
(10) Pub. No.: US 2004/0046511 A1
(43) Pub. Date: Mar. 11, 2004

(54) CONTROLLER AND METHOD FOR CREATING ADDED FUNCTIONALITY FROM A FLUORESCENT LAMP AND LIGHT FIXTURE

(76) Inventor: Ronald J. Porter, Boise, ID (US)

Correspondence Address: John R. Ley, Suite 610, 5299 DTC Boulevard, Greenwood Village, CO, 80111, US

(21) Appl. No.: 10/241,299

(22) Filed: Sep. 11, 2002

(51) Int. Cl. H05B 37/02

(52) U.S. Cl. 315/291; 315/224; 315/209 R

(57) ABSTRACT

A fluorescent lamp is ignited and extinguished in response to an external influence which is sensed at a location on the fluorescent lamp, at a starter socket of a conventional fluorescent lamp light fixture, or at a location remote from the starter socket. The controller includes a sensor which responds to the external influences and controls a starter which creates electrical conditions at filaments of the fluorescent lamp and from a magnetic ballast connected in series with the fluorescent lamp to accomplish the igniting and the extinguishing. The controller is physically connected to one of either the fluorescent lamp or within a starter socket intended to receive a conventional starter in the fluorescent lamp lighting circuit. In this manner the fluorescent lamp issues to obtain the added functionality of a motion detector, an ambient light detector, or a timer, for example.

This invention relates to fluorescent lamps and light fixtures for fluorescent lamps. More particularly, this invention relates to the new and improved combination of a starter and sensor with a fluorescent lamp, or with a light fixture having a fluorescent lamp, to create added functionality from the fluorescent lamp or the light fixture. The added functionality involves controlling the light emitted from the fluorescent lamp in response to external influences, such as ambient light, motion, automatic timing, and other things. The added functionality is conveniently achieved by replacing the fluorescent lamp or by replacing a starter for the fluorescent lamp within the light fixture, making it unnecessary to replace the entire light fixture or to wire an existing light fixture with additional components.

### BACKGROUND OF THE INVENTION

Incandescent lamps are frequently used with external devices as ambient light-responsive switches, motion detectors, automatic timers, and the like. In such cases the incandescent lamp is typically screwed into an adapter, and the adapter is screwed into the socket where the incandescent lamp is otherwise usually attached. The added functionality of lighting and extinguishing the incandescent lamp is contained in the adapter. In other cases, the added functionality to control the incandescent lamp is connected in a separate control device which is electrically connected to a conventional electrical power wall socket, and an electrical cord from the light is connected to the separate control device. One example is an ambient light responsive function, where the incandescent lamp is energized upon the detection of a low ambient light condition and de-energized when the ambient light returns to a normal level. Another example is a motion responsive detection function, where the incandescent lamp is energized upon detecting motion within a certain space and remains energized for a predetermined time after the motion ceases within that space. Still another example is an automatic timing responsive function, where the incandescent lamp is energized at a predetermined time and is de-energized at a later predetermined time.

These types of adapters and control devices are widely available, and a consumer is capable of connecting such adapters and control devices in a safe manner. The adapters and the control devices are also relatively safely and simply incorporated in adapters and control devices, because of the relatively non-complex manner in which an incandescent lamp may be energized by simply switching conventional alternating current (AC) current through the incandescent lamp to light it, and then opening the switch to terminate the AC current flow through the incandescent lamp to extinguish it.

If the consumer wishes to add additional functionality to a conventional fluorescent lamp light fixture, such as to make it responsive to ambient light, motion or automatic timing, the typical consumer must hire a skilled electrician to connect the desired control device to the fixture so that the control device causes the light source in the fixture to energize and de-energize according to the type of responsiveness desired. Alternatively, the entire light fixture must be replaced with a new light fixture that includes the added functionality. In some countries it is illegal for anyone other than a licensed or regulated electrician to wire new light fixtures or make modifications to existing light fixtures. The cost of the services of a skilled electrician is a deterrent to consumers seeking added functionality of their light fixtures.

The complexity of the functions required to ignite and extinguish a fluorescent lamp have also contributed to the inability to add new functionality to fluorescent lamps or the light fixtures in which fluorescent lamps are used. A starter and the ballast are required to ignite the typical fluorescent lamp, and the starter must create certain electrical conditions to ignite the fluorescent lamp. Simply applying conventional AC power to a fluorescent lamp will not result in lighting that lamp, as is the case with an incandescent lamp. Moreover, extinguishing a lighted fluorescent lamp is usually achieved by manually switching off the conventional AC power to the fluorescent lamp. The added functionality of the starter, coupled with the typical inability to extinguish the fluorescent lamp under appropriate conditions, have combined to substantially limit or prevent external influence-responsive control devices from being used with fluorescent lamps. In those cases where control devices have been used with fluorescent lamps, the services of a skilled electrician are typically required to connect the control devices in the lighting circuit involving the fluorescent lamp light fixture or the conventional fluorescent lamp lighting circuit had to be modified.

### SUMMARY OF THE INVENTION

This invention creates additional functionality from a fluorescent lamp or fluorescent lamp light fixture by enabling responsiveness to external influences, such as turning on and off automatically in response to ambient light, to detected motion, and to the occurrence of predetermined times, while still permitting normal lighting functionality when desired. The functionality is added to the fluorescent lamp itself, or to a separate starter associated with a light fixture, thereby permitting the consumer to replace the fluorescent lamp or the starter in the fluorescent lamp light fixture to obtain, safely and lawfully, the benefits of this additional functionality. By incorporating the added functionality in the fluorescent lamp or in a starter associated with a fluorescent lamp light fixture, no rewiring or replacement of the light fixture is required. The relatively low additional cost to incorporate the additional functionality in the fluorescent lamp or in a starter associated with a fluorescent lamp light fixture makes it attractive to a consumer to obtain the additional functionality.

One aspect of the invention relates to a controller for igniting and extinguishing a fluorescent lamp in response to an external influence. The fluorescent lamp is part of the fluorescent lighting circuit which also includes a magnetic ballast connected in series with the fluorescent lamp and an alternating current (AC) power source. The fluorescent lamp includes filaments and has a characteristic lamp ignition voltage at which an electrically conductive plasma exists between the filaments. The controller comprises a sensor which responds to the external influence and supplies a control signal related to the presence or absence of the external influence. A starter responds to the control signal to ignite and extinguish the fluorescent lamp. To ignite the fluorescent lamp, the starter conducts current through the filaments to heat them and to create a change in current per change in time (di/dt) to induce a high-voltage pulse from the magnetic ballast sufficient to ignite the plasma between the filaments at a time when the voltage from the AC power source is greater than the lamp ignition voltage. The starter also conducts current through the filaments without generating a high-voltage starting pulse to extinguish the plasma. The controller is physically connected to one of either the fluorescent lamp or within a starter socket intended to receive a conventional starter in the fluorescent lamp lighting circuit.

Other significant aspects of the invention related to the controller involve physically connecting the controller either to the exterior of the base of a fluorescent lamp or within the interior of the base of the fluorescent lamp. Alternatively, the controller can be located in a remotely positioned housing and electrically connected with a conductor and interactive electrical connectors to the base of the fluorescent lamp. As another alternative, the controller can be located within a housing that is adapted to electrically and mechanically connect to a conventional starter socket of the fluorescent lamp light fixture. As a further alternative, the housing for the controller may be remotely located and connected with an adapter and an electrical conductor into the conventional starter socket of the light fixture. In all these situations, the sensor has a field of responsiveness within which to respond to the exterior influence. A structure is attached to the base or to the housing and positioned relative to the sensor to define and limit the field of responsiveness. The sensor may comprise a motion detector, an ambient light detector or a timer, for example, in order to respond to the exterior influences of ambient light, motion or the passage of time.

Another aspect of the present invention relates to a method of igniting and extinguishing a fluorescent lamp in response to an external influence. The method involves connecting the fluorescent lamp in a fluorescent lamp lighting circuit which includes a magnetic ballast connected in series with an alternating current (AC) power source, sensing the presence and absence of the external influence, igniting the fluorescent lamp and extinguishing the fluorescent lamp in response to the presence and absence of the external influence, and sensing the external influence at a location on the fluorescent lamp or at a location within a starter socket intended to receive a conventional starter in the fluorescent lamp lighting circuit. The fluorescent lamp is ignited by conducting current through filaments of the lamp to heat them and by creating a di/dt through the magnetic ballast to induce a high-voltage pulse from the magnetic ballast sufficient to ignite the plasma. The fluorescent lamp is extinguished by conducting current through the filaments and without creating a di/dt sufficient to induce the high-voltage pulse.

Other significant aspects of the invention related to the method of igniting and extinguishing the fluorescent lamp include establishing a field of responsiveness location within which to respond to the exterior influence, and defining and limiting the field of responsiveness at the sensing location. Ambient light, motion or time may be sensed as the basis for igniting and extinguishing the fluorescent lamp.

A more complete appreciation of the scope of the present invention and the manner in which it achieves the above-noted and other improvements can be obtained by reference to the following detailed description of presently preferred embodiments taken in connection with the accompanying drawings, which are briefly summarized below, and by reference to the appended claims.

### BRIEF DESCRIPTION OF THE DRAWINGS

FIG. 1 is a perspective view of a conventional fluorescent lamp, shown in a partially exploded and broken away form.

FIG. 2 is an exploded perspective view of a conventional fluorescent lamp light fixture, including a starter and the fluorescent lamp shown in FIG. 1.

FIG. 3 is an enlarged perspective view of one type of a prior art starter which may be used in the light fixture shown in FIG. 2.

FIG. 4 is an enlarged perspective view of another type of prior art starter which may be used in the light fixture shown in FIG. 2.

FIG. 5 is a perspective view of another conventional fluorescent lamp having a self-contained starter, shown in a partially exploded and broken away form.

FIG. 6 is a schematic circuit diagram of a prior art fluorescent lamp circuit, which illustrates the role of a starter in igniting and extinguishing the fluorescent lamp.

FIG. 7 shows superimposed voltage and current waveform diagrams illustrating the functionality of the starter shown in FIGS. 2-6, in controlling the light emission from the fluorescent lamp shown in FIGS. 1, 2, 5 and 6.

FIG. 8 is a generalized schematic circuit and block diagram of a starter and sensor which cooperatively function as an external influence responsive, fluorescent lamp controller in accordance with the present invention.

FIG. 9 is a perspective view of a fluorescent lamp similar to FIG. 1, but having the controller shown in FIG. 8 attached to a base of the fluorescent lamp, in accordance with the present invention.

FIG. 10 is a perspective view of a fluorescent lamp similar to FIG. 5, but having the controller shown in FIG. 8 incorporated within a base of the fluorescent lamp, in accordance with the present invention.

FIG. 11 is a perspective of a fluorescent lamp similar to FIG. 1 or 5, but having the controller shown in FIG. 8 remotely positioned and electrically connected to a base of the fluorescent lamp by a conductor and an electrical connector, in accordance with the present invention.

FIG. 12 is an exploded perspective view of a light fixture similar to FIG. 2, but having an adapter electrically connected to a remotely connected controller shown in FIG. 8, in accordance with the present invention, with the adapter and the controller shown enlarged relative to the light fixture.

FIG. 13 is an exploded perspective view of a light fixture similar to FIG. 2, but having the controller shown in FIG. 8 used in replacement for a prior art starter, in accordance with the present invention, with the controller shown enlarged relative to the light fixture.

### DETAILED DESCRIPTION

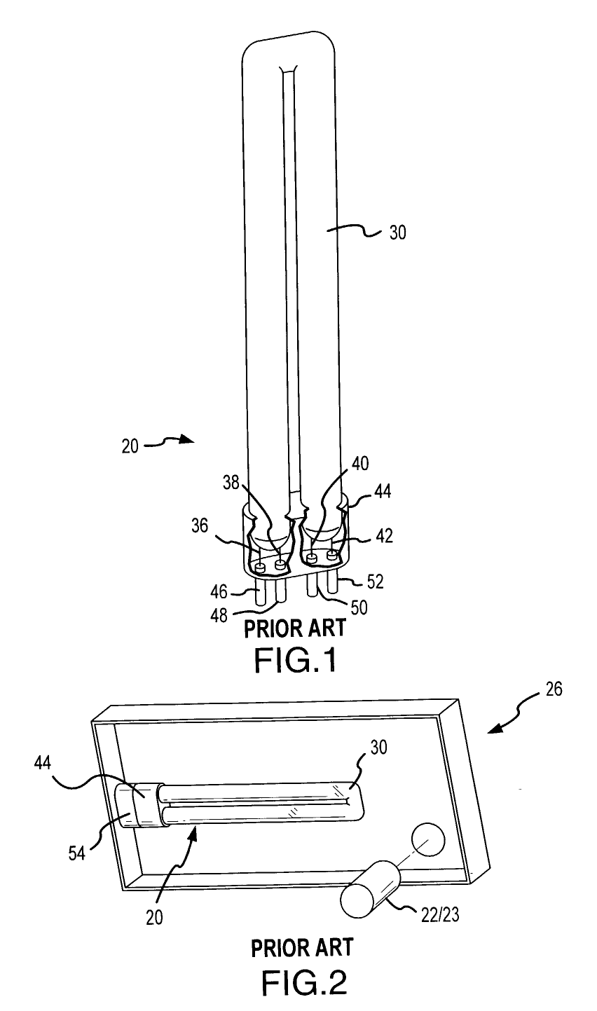

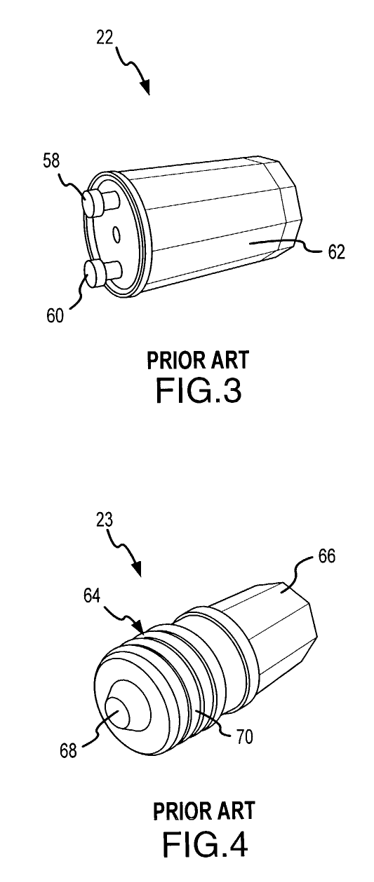

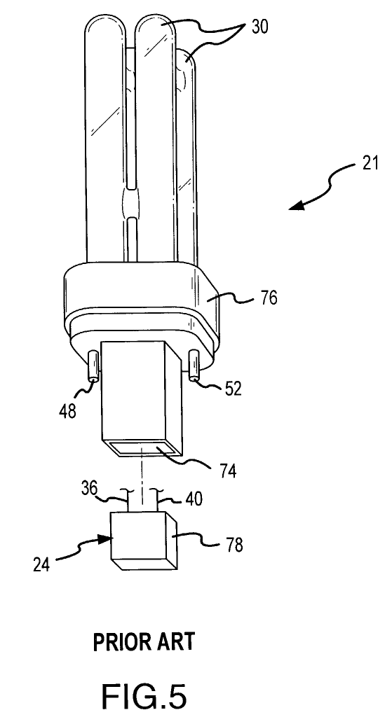

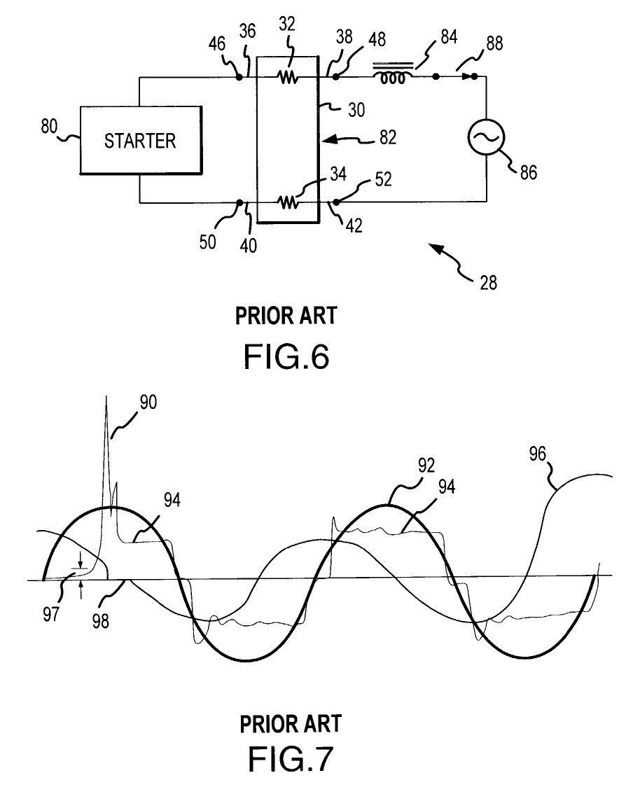

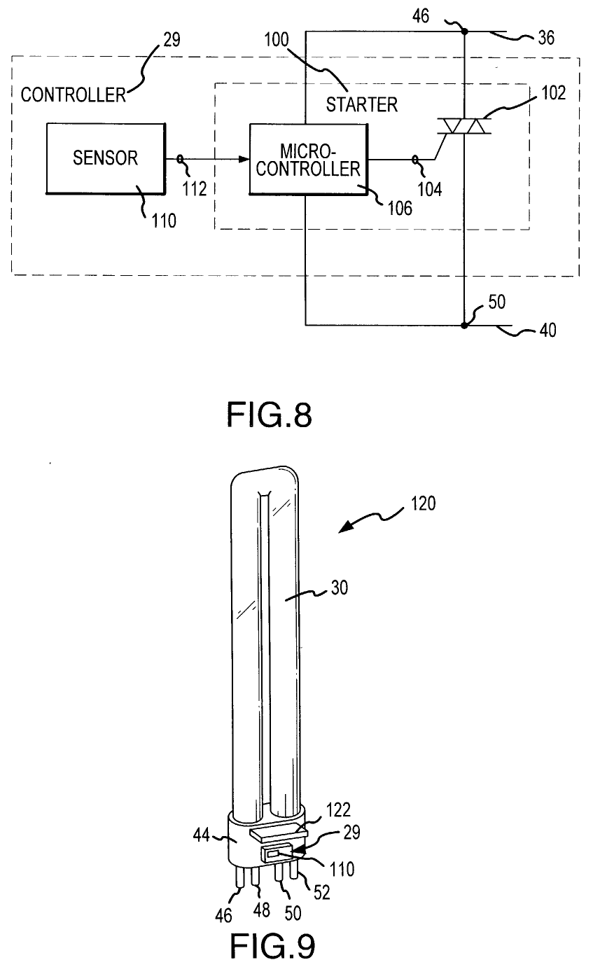

The present invention applies to conventional fluorescent lamps 20 and 21, respectively exemplified in FIGS. 1 and 5, and to conventional fluorescent lamp starters 22 and 23 respectively exemplified in FIGS. 3 and 4, which are used in a conventional fluorescent lamp light fixture 26 exemplified in FIG. 2. The connection of one fluorescent lamp and one starter is illustrated in a conventional fluorescent lamp lighting circuit 28, shown in FIG. 6. The starter ignites and extinguishes the fluorescent lamp, in the manner illustrated by exemplary voltage and current waveforms shown in FIG. 7. A fluorescent lamp controller 29 which incorporates a starter is shown in FIG. 8, and this controller 29 is the electrical basis for exemplary embodiments of the present invention shown in FIGS. 9-13.

The conventional fluorescent lamp 20, shown in FIG. 1, comprises at least one fluorescent lamp tube 30, which in the case of the fluorescent lamp 20 is bent in a single U-shaped configuration. The fluorescent lamp tube 30 is typically formed as a closed and evacuated translucent housing or glass tube which has been coated on the inside with a conventional phosphorescent material which emits light when energized. A small amount of mercury is contained within the closed tube 30. As shown in FIG. 6, filaments 32 and 34 are located within the tube 30 and at opposite ends of the tube. Conductors 36 and 38 extend through the tube 30 and connect to opposite ends of the filament 32, and conductors 40 and 42 extend through the tube 30 and connect to opposite ends of the filament 34. Electrical voltage and current is applied to the filaments 32 and 34 through the conductors 36, 38 and 40, 42, respectively, to ignite and maintain a plasma between the filaments 32 and 34. The plasma energizes the phosphorescent coating within the tube 30 to emit light. Quenching or extinguishing the electrical plasma ceases light emission from the tube 30. A starter interacts with the other elements of the fluorescent lighting circuit 28 (FIG. 6) to create the electrical conditions at the filaments 32 and 34 which ignite and extinguish the fluorescent lamp.

The tube 30 is connected to a base 44 of the fluorescent lamp 20, to thereby retain the tube 30 at a fixed position as a part of the fluorescent lamp 20, as shown in FIG. 1. The conductors 36, 38, 40 and 42 are electrically connected within the base 44 to connection pins 46, 48, 50 and 52, respectively, which extend from the base 44. The connection the pins 46-52 fit within receptacles (not shown) of a lamp socket 54 in the light fixture 26 (FIG. 2) to electrically connect the fluorescent lamp 20 to the light fixture 26 and within the fluorescent lighting circuit 28 (FIG. 6).

The fluorescent lamp 20 does not include a self-contained starter. Consequently it is necessary to use an external starter 22 or 23 (FIG. 3 or 4) with the fluorescent lamp 20 in order to ignite the plasma within the tube 30. The typical external starter 22 or 23 is connected in a starter socket 56 of the light fixture 26, as shown in FIG. 2. Connected in this manner, the external starter 22 or 23 is replaceable. The user simply disconnects the external starter 22 or 23 from the socket 56 and connects a new starter in the socket 56. In this case, the socket 56 is electrically connected to the starter shown in the lighting circuit 28 (FIG. 6). Upon insertion of an external starter 22 or 23 in the socket 56, the circuit diagram for the lighting circuit 28 appears as shown in FIG. 6.

The two general types of external starters 22 and 23 for fluorescent lamps are conventional and shown in FIGS. 3 and 4. The starter 22 shown in FIG. 3 is a typical two pin “glow bottle” starter. Two electrical pins 58 and 60 extend from a housing 62. The two pins 58 and 60 connected to electrical contacts (not shown) within the starter socket 56 (FIG. 2). The starter 23 shown in FIG. 4 is a typical screw-in “glow bottle” starter. Two electrical contacts are created by threaded end connector 64 connected to a housing 66. The threaded end connector 64 includes a center contact button 68 which is electrically insulated from an outside threaded sleeve 70. The contact button 68 and the threaded sleeve 70 form the two electrical contacts. The threaded sleeve 70 is screwed into a corresponding threaded receptacle (not shown) of the starter socket 56 (FIG. 2). Connecting the two electrical pins 58 and 60 of the starter 22 (FIG. 3) into the starter socket 56 (FIG. 2), or connecting the threaded end connector 64 of the starter 23 (FIG. 4) into the starter socket 56 (FIG. 2), connects one of the starters 22 or 23 in the lighting circuit 28, in the manner shown in FIG. 6.

The fluorescent lamp 21, shown in FIG. 5, includes its own internal starter 24 located in a starter receptacle 74 which is formed as part of a base 76 of the lamp 21. The internal starter 24 is also of the conventional “glow bottle” type, and includes a housing 78. Because the fluorescent lamp 21 utilizes its own internal starter 24, it is not necessary to provide an external starter for the fluorescent lamp 21. Instead, the internal starter 24 is electrically connected to two of the conductors 36 and 40 from the tube 30 of the lamp 21, thereby achieving the same electrical connection of the starter as shown in the fluorescent lighting circuit 28 (FIG. 6). Because the starter 24 is internally connected to the conductors 36 and 40, only two connection pins 48 and 52 are necessary in the lamp 21 for its connection in the lighting circuit 28 (FIG. 6). The internal starter 24 is usually permanently affixed within the starter receptacle 74, so that replacement of the internal starter 24 is not possible. The entire fluorescent lamp 21 must be replaced if either the fluorescent tube 30 or the internal starter 24 fails.

The fluorescent lamp 21 also exemplifies the situation where the tube 30 is bent into multiple U-shaped configurations, thereby achieving a longer fluorescent tube which emits more light than a shorter fluorescent tube 30 which is bent in only a single U-shaped configuration as shown in FIG. 1. The present invention is also applicable to fluorescent lamps which are formed in the shape of an elongated, straight cylindrical tube with electrical contacts at opposite ends.

The role of a conventional starter 22, 23 or 24 in igniting fluorescent lamp 20 or 21 can be understood by reference to the fluorescent lighting circuit 28 shown in FIG. 6, where the conventional starter is designated 80, and the fluorescent lamp is designated 82. The fluorescent lamp 82 is connected in series with a current limiting inductor known as a ballast 84. Conventional alternating current (AC) power from a source 86 is conducted through a conventional on-off light control switch 88 to the series connected lamp 82 and the ballast 84. The filaments 32 and 34 are connected by the conductors 38 and 42 and connection pins 48 and 52 to the ballast 84 and the AC source 86. The filaments 32 and 34 are connected by the conductors 36 and 40 (and connection pins 46 and 50, if used).

To initiate ignition of the lamp 82, the starter 80 first heats the filaments 32 and 34. The starter 80 establishes a current path between the conductors 36 and 40, thereby connecting both filaments 32 and 34 in a series current flow path with the AC source 86, which causes current to flow through both the filaments 32 and 34 from the AC source 86 for a period of time sufficient to heat filaments 32 and 34. The heat from the filaments helps vaporize the mercury within the tube 30. The heated filaments 32 and 34 also emit low work energy ions from material coated on the surface of the filaments. The emitted ions create an ionized cloud surrounding the filaments 32 and 34. This ionized cloud assists in establishing a break-over arc between the filaments 32 and 34 to ignite the lamp 82 and to maintain the lamp in a lighted condition.

After heating the filaments 32 and 34, the starter 80 opens the current path through the filaments 32 and 34. The current flow through the ballast 84 terminates almost instantaneously, causing a relatively high change in current in a relatively short amount of time (di/dt). The ballast 84 responds to the relatively high di/dt by producing a very high voltage pulse 90 shown in FIG. 7. The pulse 90 is of sufficiently high voltage to break down the ionized electron cloud and the mercury vapor within the tube 30, thereby conducting an arc between the filaments 32 and 34 caused by the high voltage pulse 90. The arc jumps directly between the filaments 32 and 34 because the starter 80 has opened and no longer presents a current path between the filaments. The arc creates the plasma within the tube 30, and the plasma emits ultraviolet light which interacts with phosphorus on the interior of the tube 30 to cause the phosphorus to emit visible light and ignite the lamp 82. The current flow through the plasma between the filaments 32 and 34 thereafter heats the filaments 32 and 34. The filaments are sufficiently heated to maintain enough ionization to allow the normal AC voltage 92 from the source 86 to ignite the plasma thereafter during the subsequent half cycles of applied AC voltage 92, shown in FIG. 7, without the need for further high voltage starting pulses 90.

The typical voltage characteristics applicable to the fluorescent lamp 82 are shown in FIG. 7. The applied voltage from the conventional AC source 86 (FIG. 6) is shown at 92. Under operating conditions, the voltage across the filaments 32 and 34 builds up until an ignition or break-over voltage 94 is reached. The ignition voltage may vary somewhat depending on the heat of the cathodes and the extent of vaporization, but it is necessary to apply a voltage between the filaments 32 and 34 (FIG. 6) which is at least equal to the break-over voltage 94 to sustain the plasma state. The voltage 94 remains approximately constant after steady state conditions are attained in the lamp 82. Because the peak voltage of the of the applied voltage 92 is greater than the ignition voltage 94, the arc current between the filaments 32 and 34 through the plasma will increase to an unacceptable level unless the ballast 84 is employed. The ballast 84 limits the current under normal operating conditions.

The typical type of starter 80 is a “glow bottle” starter 22, 23 or 24 shown in FIGS. 3, 4 or 5, respectively. The glow bottle starters 22, 23 or 24 have an evacuated housing 62, 66 or 78, respectively, within which there are confined a radioisotopic ionizable gas and a bimetal switch (neither shown). The voltage applied to the glow bottle starter causes current to flow through the radioisotopic gas, thereby heating the gas. The voltage at which the radioisotopic gas ionizes and begins to conduct current is above the level of the lamp ignition voltage 94 shown in FIG. 7. When the fluorescent lamp 82 is not lighted the full voltage of the AC source 86 is impressed across the radioisotopic gas. When the normally open bimetal switch becomes hot enough, it closes and shunts the current flow through the closed switch rather than the radioisotopic gas in the glow bottle. The closed bimetal switch conducts current through the filaments 32 and 34 to heat them. The radioisotopic gas starts cooling when the bimetal switch closes, because the gas is no longer heated by current flow through the gas. The bimetal switch also begins cooling when the gas is no longer heated.

When the bimetal switch has cooled sufficiently, it opens and causes a high di/dt. The ballast 84 responds to the di/dt by generating and applying the high voltage pulse 90 to the warmed filaments 32 and 34. The lamp 82 will only be lighted if the bimetal switch opens at a time when the AC voltage 92 across the filaments 32 and 34 is above the ignition voltage 94. Once the high voltage pulse 90 initiates the arc between the filaments 32 and 34, the AC voltage 92 will sustain that arc provided that it is greater than the ignition voltage 94. Once the arc is initiated and the voltage between the filaments 32 and 34 is that of the ignition voltage 94, the voltage across the radioisotopic gas in the glow bottle never reaches a high enough value to cause the radioisotopic gas to conduct current and heat the bimetallic switch because the ignition voltage 94 is lower than the ionization voltage of the radioisotopic gas. After the lamp 82 is extinguished by opening the control switch 88, the glow bottle will again become operative upon closing the control switch 88 (FIG. 6).

A conventional glow bottle starter will eventually fail from continued use. The bimetallic switch ceases to function adequately, or the radioisotopic gas loses its ability to ionize and heat up. Disposing of the worn out glow bottle starter with its radioisotopic gas presents an environmental concern. Because of these and other issues associated with glow bottle starters, electronic fluorescent lamp starters have been developed for use with conventional magnetic ballasts. Examples of electronic starters developed by the assignee of the present invention, and uses of such starters, are described in U.S. Pat. Nos. 5,504,398; 5,537,010; 5,757,145; 5,955,847; 5,708,330; 5,736,817; 5,739,640; 5,631,523; and 5,652,481. A simplified form of one such electronic starter 100 is shown in FIG. 8.

The starter 100 shown in FIG. 8 is connected to the conductors 36 and 40 or pins 46 and 50, which extend from the fluorescent lamp 82 (FIG. 6). In this regard the starter 100 is a direct replacement for the starter 80. The starter 100 utilizes a high holding current thyristor such as an SCR, a triac or other type of semiconductor current switching device, exemplified by a triac 102 (FIG. 8). The holding current of the triac 102 refers to the minimum amount of current that it will conduct between its current conduction terminals connected to the conductors 36 and 40 and pins 46 and 50, before ceasing to conduct because of its internal semiconductor characteristics. The high holding current characteristic of the triac 102 is advantageously used in the starter 100 to create the high voltage starting pulse 90 (FIG. 7) to ignite the fluorescent lamp 82 (FIG. 6).

The conductivity of the triac 102 is controlled by a micro controller 106. The micro controller 106 delivers the trigger signal 104 to the triac under predetermined conditions to cause the fluorescent lamp 82 (FIG. 6) to ignite and extinguish. The trigger signal 104 is delivered by the micro controller 106 relative to the voltage from the AC source 86 (FIG. 6) which is impressed across the filaments 32 and 34 and sensed by the connection of the micro controller 106 to the conductors 36 and 40.

To ignite the fluorescent lamp, the micro controller 106 applies the trigger signal 104 to the triac 102. The triac 102 conducts current through the filaments 32 and 34 (FIG. 6) and heats them. The triac 102 may be triggered in this manner for a series of sequential half cycles of the applied AC current 96 shown in FIG. 7, by applying and maintaining the trigger signal 104 for the entire duration of each of a predetermined number of half cycles of applied AC current during the filament warm-up period. After the filaments have been heated sufficiently, the trigger signal 104 is terminated while current flows through the triac 102 during the half cycle of applied AC current of the filament warm-up period. As the current from the applied half cycle of AC power diminishes to the holding current level of the triac 102, shown at 97 in FIG. 7, the triac immediately commutates to a nonconductive state to create the high di/dt from the ballast 84, (FIG. 6). The commutation of the triac to the non-conductive state is shown at 98 in FIG. 7. Because the relatively high holding current characteristic of the triac 102, a considerably higher di/dt is created than would exist with a conventional semiconductor switch device which has a lower holding current characteristic. This relatively high di/dt causes the ballast 84, (FIG. 6) to generate the high voltage pulse 90, thereby igniting the lamp.

Because the inherent characteristics of the ballast 84 cause a phase shift of the current by about 90 degrees in time relative to the voltage, the high voltage pulse 90 occurs when the impressed voltage 92 across the filaments 32 and 34 is near its peak value and above the ignition voltage level 94. This timing maximizes the opportunity to ignite the mercury plasma in the fluorescent lamp. After ignition, the plasma is sustained by the applied AC voltage for the duration of that half cycle. Subsequent half cycles of applied AC voltage 92 directly ignite the plasma in the lamp tube for the reasons previously described. If the lamp is not immediately ignited by the first high voltage pulse 90, the micro controller 106 will sense that the lamp has not ignited and will again perform the starting sequence until the lamp lights.

To extinguish the lamp, the micro controller 106 applies the trigger signal 104 to the triac 102 continuously for an entire half cycle. The triggered triac 102 connects the filaments 32 and 34 and prevents current flow through the gas between them. The plasma in the lamp 82 is immediately extinguished. As the current flowing through the filaments 32 and 34 decreases to the holding level of the triac 102 at the end of the half cycle of applied AC current, the trigger signal 104 is continually applied to prevent the triac 102 from commutating into a nonconductive state as the current passes through the holding current level. This inhibits the generation of the di/dt effect, which prevents the generation of a starting pulse. Without a starting pulse, the lamp remains extinguished. The filaments 32 and 34 cool sufficiently to no longer ignite the plasma just from the applied AC voltage. Thereafter, the micro controller 106 no longer delivers trigger signals 104 to the triac 102. The fluorescent lamp is thus quickly extinguished within one cycle of applied AC power.

The fluorescent starter 100 is effective in lighting the fluorescent lamp by creating a high di/dt at the time when the voltage across the cathodes nears its peak, thereby enhancing ignition of the lamp. Reliable ignition of the lamp is achieved on a very rapid basis. Moreover, the ability to control the triac 102 for the purpose of extinguishing the plasma and to prevent the generation of the high voltage starting pulses allows the starter 100 to quickly extinguish the lighted fluorescent lamp.

The fluorescent lamp controller 29 of the present invention uses the starter 100 and a connected sensor 110, as shown in FIG. 8. The sensor 110 supplies a control signal 112 to the starter 100, in response to the external conditions to which the sensor 110 responds. For example, the sensor 110 could be a conventional ambient light detector, in which case the control signal 112 would be delivered in response to ambient light conditions. In this example, the presence of a predetermined degree of ambient light indicative of normal daylight would result in the assertion of the control signal 112, and the other ambient light condition indicating natural darkness would result in de-assertion of the control signal 112. The sensor 110 could also be a conventional motion detector, for example. In this case the control signal 112 would be asserted in response to the detection of movement and would be de-asserted in response to the absence of movement after a predetermined time. The sensor 110 might be a conventional radio receiver, for example. In this example, the radio receiver responds to the reception of a radio signal to assert the control signal 112 and responds to the absence of the radio signal to de-assert the control signal 112. The sensor 110 could also be a conventional timer which asserts the control signal 112 at a predetermined time and de-asserts the control signal 112 at a later, predetermined time, for example. Many other types of external influences can be sensed by an appropriate sensor 110, as a basis for asserting and de-asserting the control signal 112.

In accordance with the present invention, the starter 100 becomes operative and ceases operation in response and relation to the assertion and de-assertion of the control signal 112 from the sensor 110. For example, when the sensor 110 is a motion detector and the lamp controller 29 thereby functions to detect motion and ignite the fluorescent lamp, the assertion of the control signal 112 causes the starter 100 to ignite the fluorescent lamp. After a predetermined time has elapsed and no further motion has been sensed, the sensor 110 de-asserts the control signal 112. The starter 100 responds to the de-asserted control signal 112 and functions as described above to extinguish the fluorescent lamp.

The fluorescent lamp controller 29 is combined with a fluorescent lamp, e.g. 20 or 21 (FIG. 1 or 5), or with a light fixture 26 (FIG. 2), to obtain the improvements of the present invention in the manner illustrated in FIGS. 9-13. In each case, the lamp controller 29 is either attached to the fluorescent lamp or replaces a conventional starter. The sensor 110 (FIG. 8) is located or oriented to respond to the external influence which it senses, and in response the fluorescent lamp is ignited and extinguished. This added functionality is created by either replacing the fluorescent lamp with a fluorescent lamp that has an attached lamp controller 29, or by replacing the starter with a lamp controller 29.

A fluorescent lamp 120 with the lamp controller 29 attached externally to its base 44, is shown in FIG. 9. The fluorescent lamp 120, shown in FIG. 9, is similar to the fluorescent lamp 20, shown in FIG. 1, except that the lamp controller 29 containing the starter 100 and sensor 110 (FIG. 8), is incorporated into the base 44. The lamp controller 29 is electrically connected to the conductors 36 and 40 from the tube 30 of the fluorescent lamp 120, thereby achieving the same electrical connection of the lamp controller 29 in the fluorescent lighting circuit 28, as the starter 80 is electrically connected in the fluorescent lighting circuit 28 (FIG. 6).

Depending on the type of external influence to which the sensor 110 responds, it may be advantageous to include a shield 122 adjacent to the sensor for the purpose of focusing or limiting the response area or field of view of the sensor 110. For example, if the lamp controller 29 is an ambient light responsive detector, the shield 122 shadows the sensor 110 from the light generated by the lamp 30. The shield 122 allows the ambient light detector to respond to the ambient light conditions of the room, without the light generated by the lamp interfering with the ability of the detector to respond to ambient light. If the sensor 110 of the lamp controller 29 is a motion detector, the shield 122 limits the responsiveness of the sensor to a specific direction or area in which motion is to be detected. The shield 122 may also include a lens or be replaced by a lens to define the field of view or the field of responsiveness of the sensor 110. In this regard, the shield 122 is exemplary of a structure used in conjunction with the sensor 110 to define a field of view or field of responsiveness with respect to the external influences which are sensed.

In use, the lamp controller 29 ignites the plasma in the lamp 30 in response to the external influences which it senses, and extinguishes the plasma in the lamp in response to the absence of the external influences which it senses. These benefits may be obtained by the simple expedient of replacing an existing fluorescent lamp with the fluorescent lamp 120 which incorporates the lamp controller 29. In circumstances where an external starter is normally used with the fluorescent lamp, it is no longer necessary to use the external starter because starter functionality is incorporated within the lamp controller 29.

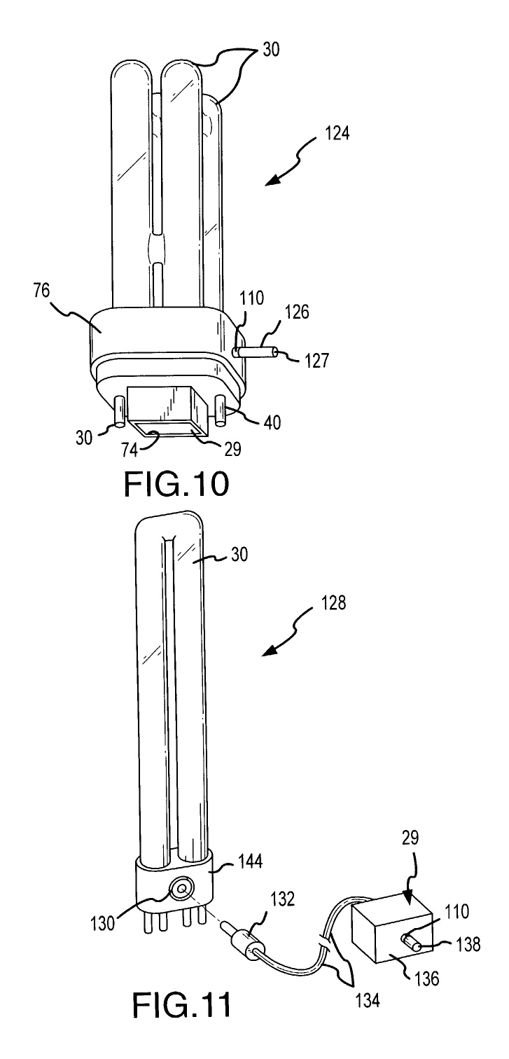

Another fluorescent lamp 124 with the lamp controller 29 attached internally within its base 76, is shown in FIG. 10. The fluorescent lamp 124, shown in FIG. 10, is similar to the fluorescent lamp 21, shown in FIG. 5, except that the lamp controller 29 is primarily incorporated in the starter receptacle 74 as a replacement for the conventional starter which is normally used with the fluorescent lamp 21 (FIG. 5). The sensor 110 of the lamp controller 29 is attached at an external surface of the base 76 by electrical conductors which connect it to the remaining components of the lamp controller 29.

A hollow tube 126 surrounds the sensor 110 and protrudes from one side of the base 76. The light or other manifestation of the external influence which is sensed enters an open end 127 of the tube 126 and is received by the sensor 110. In this manner the tube 124 defines a field of view or a field of responsiveness of the sensor 110. Only that light or other external influence which enters the open end 127 of the tube 126 and reaches the sensor 110 has an affect on the sensor 110. Although not shown, a lens may be located at the open end 127 to focus light into the tube 126 and onto the sensor 110, or to establish a larger field of view as would otherwise be established by the tube 126 itself.

The sensor 110 and the tube 126 are oriented on the base 76 of the fluorescent lamp 124 so that when the fluorescent lamp 126 is installed in its normal use position, the field of view or field of responsiveness is directed toward the location where the external influence is to be sensed, relative to the installed position of the fluorescent lamp 124. For example, if the lamp controller 29 is a motion detector, the sensor 110 and tube 126 are pointed in the direction where the motion is to be sensed, relative to the installed position of the fluorescent lamp 124. As another example, if the lamp controller 29 is an ambient light detector, the sensor 110 and tube 126 are oriented on the base 76 to point in the direction where the ambient light is to be sensed. In this regard, the tube 126 also functions to block the light generated by the tube 30 of the fluorescent lamp 124 which is outside the field of view or field of responsiveness. Again, the user is able to achieve added functionality from the present invention by simply replacing the existing conventional fluorescent lamp 21 (FIG. 5) with the fluorescent lamp 124.

The present invention may also be embodied in a fluorescent lamp 128 and a remotely positioned lamp controller 29 as shown in FIG. 11. The fluorescent lamp 128, shown in FIG. 11, is similar to the fluorescent lamp 20, shown in FIG. 1, except that an electrical socket 130 is located in the base 44. A removable electrical connector 132 connects to and mates with the electrical socket 130. The electrical connector 132 is attached to a two-wire electrical conductor 134, and the other end of the electrical conductor 134 is connected to the remotely positioned lamp controller 29. In this manner, the lamp controller 29 may be located at a position remotely spaced from the fluorescent lamp 128.

The remote lamp controller 29 includes its own starter 100 and sensor 110 (FIG. 8). The remote lamp controller 29 is connected to the fluorescent lamp tube 30 by the electrical conductor 134, the socket 130 and the connector 132. The remote lamp controller 29 is confined within a housing 136, and the sensor 110 of the lamp controller 29 is exposed at the exterior of the housing 136. A tube 138 is attached to the exterior of the housing 136 in a position which surrounds the sensor 110. The tube 138 defines a field of view or field of responsiveness within which the external influences cause the sensor 110 to respond. In this regard, the tube 138 functions in a similar manner to the tube 126 (FIG. 10).

The socket 130, connector 132 and electrical conductor 134 permit the lamp controller 29 to be positioned at a remote location relative to the fluorescent tube 30. The lamp controller 29 can be remotely located in an advantageous position to sense the external influences, and any unwanted influence created by the light from the fluorescent lamp 128 may be moderated or eliminated by the remote location of the lamp controller 29. Even at the remote location, the tube 138 may be used in an advantageous manner similar to the use of the tube 128 (FIG. 10), because the tube 138 protrudes from the housing 136 to facilitate or limit the definition of the field of view or the field of responsiveness of the sensor 110. For example, in the case of the lamp controller 29 performing an ambient light sensing function, the remote lamp controller 29 is placed at a location away from the light fixture to prevent the sensor 110 from responding to the light generated by the fluorescent lamp 128.

Again, with respect to the fluorescent lamp 128, the user is able to obtain the added functionality from the present invention by replacing the conventional fluorescent lamp 20 (FIG. 1) with the fluorescent lamp 128 and connecting the remotely located lamp controller 29 to the fluorescent lamp 128 by connecting the connector 132 into the socket 130. No external starter is needed for the fluorescent lamp 128, because the lamp controller 29 performs the starter functionality.

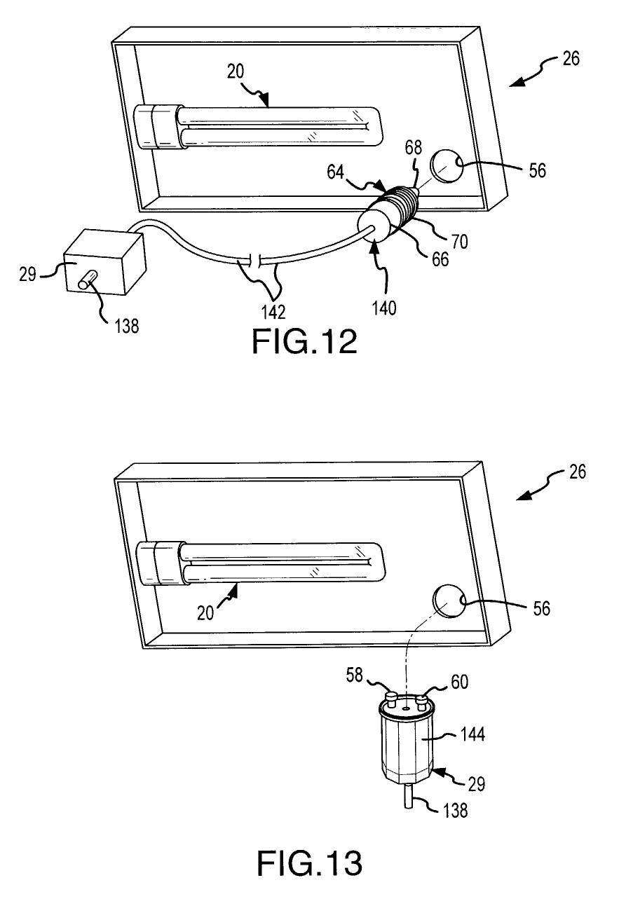

Improvements of the present invention may also be obtained without replacing a conventional fluorescent lamp fixture 26 in the manner shown in FIG. 12. An adapter 140 is connected into the conventional starter socket 56. A remotely located lamp controller 29 is electrically connected to the adapter 140 by an electrical conductor 142. The remotely located lamp controller 29 shown in FIG. 12 is similar to the one described and shown in FIG. 11. Since the lamp controller 29 also contains the starter 100 in addition to the sensor 110 (FIG. 8), the adapter 140 simply electrically connects the lamp controller 29 to the fluorescent lamp 20 in the light fixture 26 in the same manner that a conventional starter is connected in the lighting circuit 28 (FIG. 6). However, the sensor of the lamp controller 29 responds to external influences in the same manner previously described in connection with FIGS. 9-11. The remotely located lamp controller 29 obtains the added functionality from the light fixture 26 without replacing the light fixture, by simply replacing the conventional starter which normally fits within the starter socket 56 with the adapter 140 and positioning the remotely located lamp controller 29 at the desired location to respond to the external influences within the field of view or the field of responsiveness.

Improvements of the present invention may also be obtained by simply replacing the conventional starter with a lamp controller 29, as shown in FIG. 13. The lamp controller 29 provides the functionality of both the starter 100 and the sensor 110 (FIG. 8) incorporated within a housing 144. The sensor is located at the exterior of the housing 144, and a tube 138 defines a field of view or field of responsiveness for the sensor in the same manner as has been previously described in conjunction with FIGS. 11 and 12. The tube 138 may be made long enough, or may be made out of conductive material such as fiber optic material, to conduct the manifestation of the external influence which is sensed to the sensor. The sensor itself can be located on the terminal end of the tube 138, or a lens may be used to direct light through the tube 138 to the sensor. In any event, the tube 138 is oriented to obtain the desired field of view or field of responsiveness. In most cases, the desired field of view or field of responsiveness will be directly away from the light fixture 26 because the tube 138 is oriented to detect external influences directly away from the light fixture 26. In this manner, added functionality is obtained from the light fixture 26 in accordance with the present invention.

As is apparent from the previous description, the starter functionality of the fluorescent lamp controller 29 has the capability of igniting and extinguishing the fluorescent lamp on a reliable and consistent basis. Incorporating the sensor in the lamp controller permits the starter functionality to be controlled in response to the external influences which are sensed, thereby adding additional functionality to the fluorescent lamp or the fluorescent lamp light fixture. Moreover, by incorporating the functionality of the fluorescent lamp controller 29 into the fluorescent lamp itself or into a housing which can be remotely positioned and connected to the fluorescent lamp, or by connecting the fluorescent lamp controller 29 into a fluorescent lamp light fixture, a user or consumer can easily obtain the added functionality by simply replacing the conventional fluorescent lamp or fluorescent starter as described above. The added functionality is obtained in this manner without requiring the services of a skilled electrician to wire additional components to an existing fluorescent lamp light fixture or to change to the standard fluorescent lamp light circuit 28 shown in FIG. 6. Preserving the conventional fluorescent lamp lighting circuit 28 (FIG. 6) in its conventional form also facilitates the direct and simple replacement of the conventional fluorescent lamp and starter with those items of the invention as described above. For example, if a different type of fluorescent lamp controller was used which employed a so-called electronic ballast, the conventional fluorescent lamp lighting circuit 28 would have to be altered to eliminate the magnetic ballast 84 (FIG. 6). Such alterations would require the services of a skilled electrician. The lamp controller 29 of the present invention operates in a conventional fluorescent lamp lighting circuit 28 in place of the conventional starter to provide its significant improvements. Other improvements will be apparent upon gaining a full understanding of the present invention.

Presently preferred embodiments of the invention and many of its improvements have been described with a degree of particularity. This description is not necessarily intended to limit the scope of the invention. The scope of the invention is defined by the following claims.

What is claimed is:

1. A controller for igniting and extinguishing a fluorescent lamp in a fluorescent lamp lighting circuit in response to an external influence, the lighting circuit including a magnetic ballast connected in series with the fluorescent lamp and an alternating current (AC) power source which supplies voltage and current to the lighting circuit, the fluorescent lamp including filaments and having a characteristic lamp ignition voltage at which an electrically conductive plasma exists between the filaments, the controller comprising:
a sensor responsive to the external influence and operative to supply a control signal having one state related to the presence of the external influence and another state related to the absence of the external influence;
a starter electrically connected to receive the control signal from the sensor and electrically connected to the filaments of the fluorescent lamp, the starter responding to one state of the control signal to ignite the fluorescent lamp and responding to the other state of the control signal to extinguish the fluorescent lamp, the starter conducting current through the filaments to heat the filaments and to create a change in current per change in time (di/dt) to induce a high-voltage pulse from the magnetic ballast sufficient to ignite the plasma between the filaments at a time when the voltage from the AC power source is greater than the lamp ignition voltage, the starter also conducting current through the filaments without creating a di/dt sufficient to induce the high-voltage pulse to extinguish the plasma; and
a physical connection of the controller to one of either the fluorescent lamp or within a starter socket intended to receive a conventional starter in the fluorescent lamp lighting circuit.

2. A controller as defined in claim 1, wherein the fluorescent lamp includes a base; and
the physical connection locates the controller on the exterior of the base.

3. A controller as defined in claim 2, wherein:
the sensor has a field of responsiveness within which to respond to the exterior influence, and further comprising:
a structure attached to the base and positioned relative to the sensor to define and limit the field of responsiveness.

4. A controller as defined in claim 3, wherein:
the structure comprises a shield attached to the base and positioned relative to the sensor.

5. A controller as defined in claim 3, wherein:
the structure comprises a tube attached to the base and having a hollow interior through which the field of responsiveness extends.

6. A controller as defined in claim 1, wherein the fluorescent lamp includes a base;
the physical connection locates the controller within the interior of the base, and
the base defines an opening through which the sensor responds to the exterior influence.

7. A controller as defined in claim 6, wherein:
the sensor has a field of responsiveness within which to respond to the exterior influence, and further comprising:
a structure attached to the base and positioned relative to the sensor and the opening in the base to define and limit the field of responsiveness.

8. A controller as defined in claim 7, wherein:
the structure comprises a shield attached to the base and positioned relative to the sensor.

9. A controller as defined in claim 7, wherein:
the structure comprises a tube attached to the base and having a hollow interior through which the field of responsiveness extends.

10. A controller as defined in claim 1, wherein the fluorescent lamp includes a base;
the controller is located within a housing; and
the physical connection includes a first electrical connector connected to the base of the fluorescent lamp, a second electrical connector adapted to mate with the first electrical connector, and an electrical conductor extending remotely to the housing and connected between the second electrical connector and the controller within the housing.

11. A controller as defined in claim 10, wherein:
the housing defines an opening through which the sensor responds to the exterior influence;
the sensor has a field of responsiveness within which to respond to the exterior influence, and further comprising:
a structure attached to the housing and positioned relative to the sensor and the opening in the housing to define and limit the field of responsiveness.

12. A controller as defined in claim 11, wherein:
the structure comprises a shield attached to the housing and positioned relative to the sensor.

13. A controller as defined in claim 11, wherein:
the structure comprises a tube attached to the housing and having a hollow interior through which the field of responsiveness extends.

14. A controller as defined in claim 1, wherein the fluorescent lamp lighting circuit includes a light fixture having a lamp socket to connect the fluorescent lamp and having the starter socket, the starter socket and the lamp socket being electrically connected in the lighting circuit, wherein:
the controller is located within a housing;
the housing has a configuration to electrically and mechanically connect within the starter socket; and
the physical connection includes the electrical and physical connection of the housing within the starter socket.

15. A controller as defined in claim 14, wherein:
the housing defines an opening through which the sensor responds to the exterior influence;
the sensor has a field of responsiveness within which to respond to the exterior influence, and further comprising:
a structure attached to the housing and positioned relative to the sensor and the opening in the housing to define and limit the field of responsiveness.

16. A controller as defined in claim 15, wherein:
the structure comprises a shield attached to the housing and positioned relative to the sensor.

17. A controller as defined in claim 15, wherein:
the structure comprises a tube attached to the housing and having a hollow interior through which the field of responsiveness extends.

18. A controller as defined in claim 1, wherein the fluorescent lamp lighting circuit includes a light fixture having a lamp socket to connect the fluorescent lamp and having the starter socket, the starter socket and the lamp socket being electrically connected in the lighting circuit, wherein:
the controller is located within a housing; and
the physical connection includes an adapter to electrically and mechanically connect into the starter socket and an electrical conductor extending remotely to the housing and connected between the adapter and the controller within the housing.

19. A controller as defined in claim 18, wherein:
the housing defines an opening through which the sensor responds to the exterior influence;
the sensor has a field of responsiveness within which to respond to the exterior influence, and further comprising:
a structure attached to the housing and positioned relative to the sensor and the opening in the housing to define and limit the field of responsiveness.

20. A controller as defined in claim 19, wherein:
the structure comprises a shield attached to the housing and positioned relative to the sensor.

21. A controller as defined in claim 19, wherein:
the structure comprises a tube attached to the housing and having a hollow interior through which the field of responsiveness extends.

22. A controller as defined in claim 1, wherein:
the sensor comprises an ambient light detector and the external influence is a predetermined amount of ambient light.

23. A controller as defined in claim 1, wherein:
the sensor comprises a motion detector and the external influence is a predetermined amount of motion.

24. A controller as defined in claim 1, wherein:
the sensor comprises a timer and the external condition is defined by the occurrence of at least one predetermined time.

25. A method of igniting and extinguishing a fluorescent lamp in response to an external influence, the fluorescent lamp including filaments and having a characteristic lamp ignition voltage at which an electrically conductive plasma exists between the filaments while the fluorescent lamp is ignited and an absence of the conductive plasma when the fluorescent lamp is extinguished, comprising:
connecting the fluorescent lamp in a fluorescent lamp lighting circuit which includes a magnetic ballast connected in series with the fluorescent lamp and an alternating current (AC) power source which supplies voltage and current to the lighting circuit;
sensing the presence of the external influence and the absence of the external influence;
igniting the fluorescent lamp in response to one of either the presence or the absence of the external influence;
extinguishing the fluorescent lamp in response to the other one of the presence or absence of the external influence;
igniting the fluorescent lamp by conducting current through the filaments to heat to filaments and by creating a change in current per change in time (di/dt) through the magnetic ballast to induce a high-voltage pulse from the magnetic ballast sufficient to ignite the plasma between the filaments at a time when the voltage from the AC power source is greater than the lamp ignition voltage;
extinguishing the fluorescent lamp by conducting current through the filaments and without creating a di/dt sufficient to induce the high-voltage pulse; and
establishing a location for sensing the external influence at the fluorescent lamp, at a starter socket intended to receive a conventional starter in the fluorescent lamp lighting circuit, or at a remote position relative to the starter socket.

26. A method as defined in claim 25, further comprising:
establishing a field of responsiveness within which to respond to the exterior influence; and
defining and limiting the field of responsiveness at the sensing location.

27. A method as defined in claim 25, further comprising:
sensing a predetermined amount of ambient light as the external influence.

28. A method as defined in claim 25 wherein:
sensing a predetermined amount of motion as the external influence.

29. A method as defined in claim 25 wherein:
sensing at least one predetermined time as the external influence.
